(19) United States
(12) Patent Application Publication
(10) Pub. No.: US 2022/0279960 A1
(43) Pub. Date: Sep. 8, 2022

(54) MULTI-PURPOSE DRINK MACHINE

(71) Applicant: PETER GIA VU, KENTWOOD, MI (US)

(72) Inventor: PETER GIA VU, KENTWOOD, MI (US)

(21) Appl. No.: 17/683,481

(22) Filed: Mar. 1, 2022

Related U.S. Application Data
(60) Provisional application No. 63/155,305, filed on Mar. 2, 2021.

(51) Int. Cl. A47J 31/44; A47J 31/46; A47J 31/52

(52) U.S. Cl. CPC A47J 31/4485; A47J 31/468; A47J 31/461; A47J 31/465; A47J 31/5253

(57) ABSTRACT

Described herein is a multi-purpose drink or beverage machine. The inventive concept is equipped with a control panel, beverage making stations including a frothing assembly or standalone device configured to froth dense liquids and aid in tea infusion for tea beverages. In a related embodiment, beverage medium storage racks and trays are included on the brewing station housing. The multipurpose drink machine contains pumps, tubes, heaters, and a water spigot assembly to receive water and direct it to the appropriate brewer. The inventive concept also includes a standalone heating frother assembly. The inventive concept further includes a power source and a microprocessor controlled system designed for functionality including beverage sequencing and controlled power consumption by more than one brew station operating simultaneously.

### CLAIM OF PRIORITY

This application claims priority to and the benefit of U.S. provisional application with Ser. No. 63/155,305 filed on Mar. 2, 2021, with the same title, which is hereby incorporated by reference in its entirety.

### FIELD OF THE INVENTION

The inventive concept relates generally to a multi-purpose drink machine.

### BACKGROUND

Currently, there are a number of solutions for making drinks. One of these solutions attempts to utilize a coffee maker, but this solution fails to meet the needs of the market because coffee makers are focused on one function. Another solution attempts to buy drinks, but this solution is similarly unable to meet the needs of the market because buying drinks can be expensive and inconvenient. Still another solution seeks to utilize a tea pot, but this solution also fails to meet market needs because making tea can be inconvenient. Therefore, there currently exists a need in the market for an improved apparatus that makes multiple drinks.

### SUMMARY OF THE INVENTION

A heated beverage maker for a user has a housing assembly with three brewing stations further comprising a water tank member. A pump and tube assembly is operably coupled at a distal end of the pump and tube assembly to the water tank member and a proximal end of the pump and tube to three dispensing nozzle members. The heater beverage maker includes at least one metal portion of the tube assembly. A valve assembly is operably coupled to the pump and tube assembly designed to direct water flow to at least one or more of the dispensing nozzle members selected by the user. At least one water heater assembly is operably coupled to at least one heater portion of the at least one tube assembly. The heater beverage maker includes a water level indicator viewing port. heater beverage maker includes at least one grated container member with a watertight basin. A plurality of top lid members is designed for adding water and at least one brewing medium. The heater beverage maker includes at least one removable carafe member. A plurality of drawer members is slidably disposed within the housing assembly. The heater beverage maker includes at least one tray member with at least one sidewall member. The heater beverage maker includes at least one removable beverage medium pod container member with a plurality of bottom hole members having a pod container lid member, the pod container lid member having a central hole member, each central hole member aligned to a user-selected one of the three dispensing nozzle members when making a beverage. At least one filter basket member is designed to be removably disposed within the at least one beverage medium pod member. At least one rack portion is disposed within the housing assembly with a plurality of horizontally disposed, C-shaped holder members, the open bowl of the C-shaped holder members outwardly disposed. A control panel assembly is designed to control at least one or more of power, time, timer, timing, pre-programming, cleaning, beverage size, type of beverage, beverage strength, drip style, temperature, start of a brewing cycle, end of a brewing cycle, and brewing station selection. A power assembly with at least one power chord member is designed to be plugged into an outlet. At least one central processing unit operably coupled to the control panel assembly and electrically coupled to the power assembly is designed to process commands from the control panel.

Embodiments of the heated beverage maker may include at least one hot plate assembly. In one embodiment of the heated beverage maker for a user, at least one tray member is disposed beneath the at least one grated container member.

It would be advantageous to have a heated beverage maker that is reusable. Furthermore, it would be advantageous to have a heated beverage maker that is versatile. Still further, it would be advantageous to have a heated beverage maker that is interchangeable.

The heated beverage maker advantageously fills the aforementioned deficiencies by providing a multi-purpose drink machine, which provides a convenient way to make different drinks using the same machine. The heated beverage maker may include digital displays. The heated beverage maker has at least two brewing stations.

Among other things, it is an advantage of the heated beverage maker to provide a multi-purpose drink machine that does not suffer from problems or deficiencies associated with prior solutions. It is still further an advantage of the heated beverage maker to be reusable. Still further, the heated beverage maker has coffee pod holders.

In one example embodiment, beverage maker or appliance is provided that includes a housing assembly with at least two brewing stations further including a water source for common or shared usage by each brewing station and a pump and tube assembly operably coupled between the water source and at least two dispensing nozzle members, the dispensing nozzle members having distal ends directed at one of at least a pod carrier or a coffee basket. There is also included a valve assembly operably coupled to the pump and tube assembly and designed to direct water flow to one or more dispensing nozzle members selected by a user and includes at least one water heater assembly operably coupled to the valve assembly and the pump and tube assembly adapted to provide heated water to the dispensing nozzle member. The appliance also includes a frothing assembly having a container assembly and a stirring assembly, the container assembly including a container supporting a strainer and a stirring member; a control panel assembly adapted to control at least one or more of power, time clock, timer, timing, pre-programming, cleaning, beverage size, type of beverage, beverage strength, drip style, temperature, start of a brewing cycle, end of a brewing cycle, brewing station selection, and stirring. A power assembly is included with at least one power cord member adapted to be plugged into an outlet; and at least one central processing unit (CPU) operably coupled to the control panel assembly and electrically coupled to the power assembly adapted to process commands from the control panel. In a related embodiment, a water spigot assembly is also include that is designed to receive water from the water source and direct the water to at least one of the brewing stations and the frothing assembly. In another related embodiment, there is wherein the frothing assembly is configured for use as a tea brewing station and in a related embodiment includes a stirring assembly including a rotating magnet for imparting a magnetic force on the stirring member within the container.

In another example embodiment, there is provided a frothing assembly, either standalone or can be integrated into a brewing station, including a housing assembly with a base portion, a vertical support member coupled to the base portion and extending longitudinally therefrom, a vertical track member. The frothing assembly further includes a motor support column member movably coupled co-linearly to the vertical support member at the vertical track, the motor support column member adapted to move in the vertical direction along the vertical track, the motor support column having an arm extending laterally therefrom and over the base portion. Also included is a motor assembly coupled to the laterally extending arm, the motor assembly extending downward towards the base portion and including and an axle member protruding down from the motor assembly, wherein the axle is coupled at a proximal end to the motor assembly is designed to be rotated by the motor assembly upon actuation. Further included is a whisk assembly including a whisk member disposed on a disc or circular plate, wherein the disc is designed to be attached to a distal end of the axle to enable spinning or rotating of the disc and whisk member; wherein the base portion is configured to receive a container or cup with an opening that extends up from the base portion and towards the axle member and the whisk assembly.

In related embodiments, the axle member includes a shroud or cover that extends over and in close proximity to the whisk assembly and a base portion that is capable of receiving power from an external source to power the components of the frothing assembly and to power an induction coil assembly disposed within the base portion. In another embodiment, the disc or circular plate is metal and the induction coil assembly, upon activation, provides energy to the metal disc to generate resistive heating about the whisk member. In yet another embodiment, there is included an infrared sensor located on the motor assembly adjacent the axle member, the infrared sensor configured to sense temperature of a fluid in the container located on the base portion.

In yet another embodiment of the frothing assembly there are included a control panel assembly adapted to control at least one or more of power, temperature of a frothed liquid, start of a frothing cycle, and end of a frothing cycle; a power assembly disposed within the base portion with at least one power cord member adapted to be plugged into an outlet; and at least one central processing unit operably coupled to the control panel assembly and electrically coupled to the power assembly adapted to process commands from the control panel.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a front view of a first embodiment of a multi-purpose drink machine according to the teachings herein.

FIG. 2 illustrates a left perspective view of the multi-purpose drink machine.

FIG. 3 illustrates a right perspective view of the multi-purpose drink machine.

FIG. 4 illustrates a rear perspective view of the multi-purpose drink machine with various components.

FIG. 5 illustrates a schematic of the system and controller of the multi-purpose drink machine.

FIG. 6 illustrates a front view of a second embodiment of a multi-purpose drink machine or appliance.

FIGS. 7A-7B illustrate cutaway views of a tea or flavoring infusion accessory to the multi-purpose drink machine and mode of operation.

FIG. 8 illustrates a schematic of the system and controller of the second embodiment of the multi-purpose drink machine.

FIG. 9 illustrates a heating frother assembly and accessory that can be integrated into the various embodiments of brewing systems described herein.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

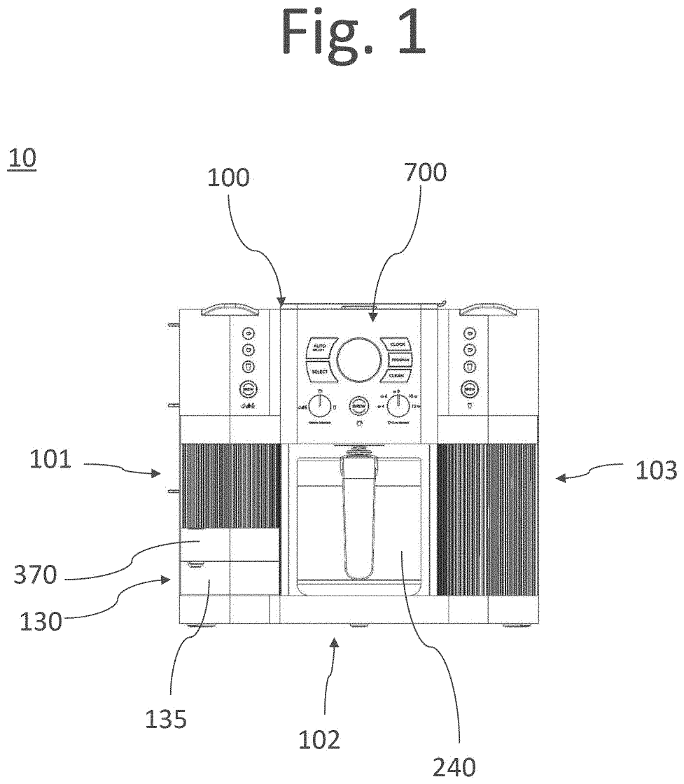

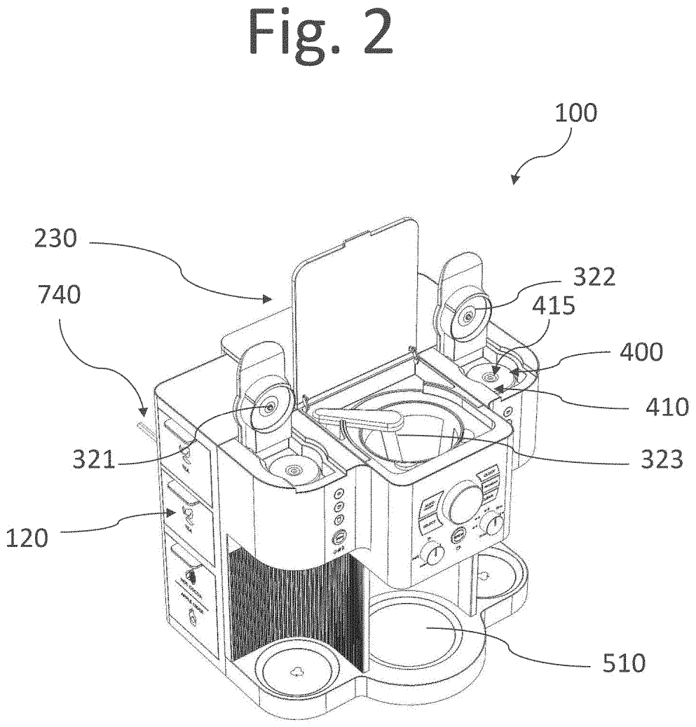

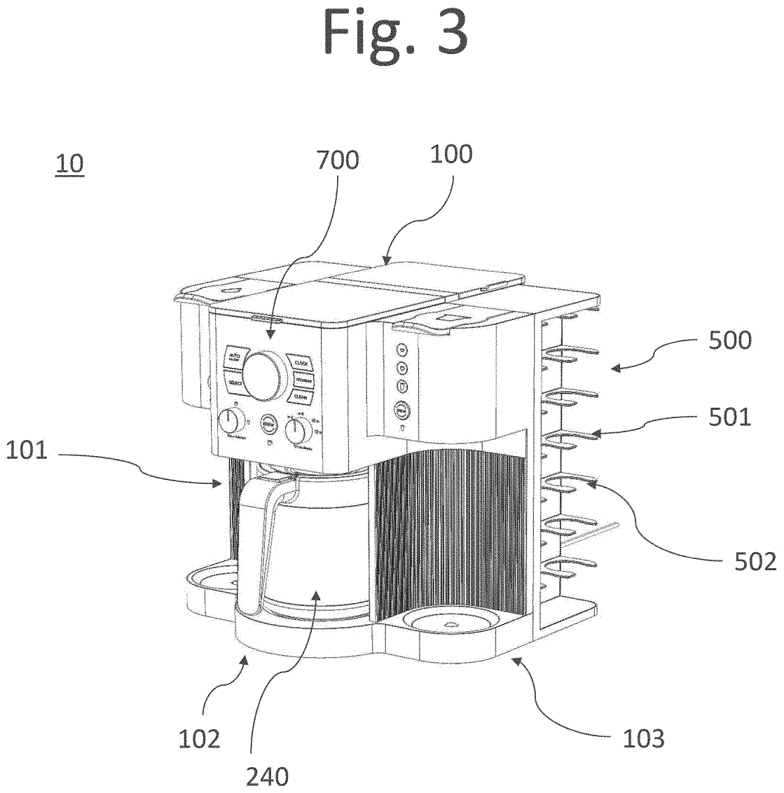

Referring to the figures, FIGS. 1-5 illustrate a first embodiment of a multi-purpose drink machine heated beverage maker 10 for a user that has a housing assembly 100 with three brewing stations 101, 102, 103 further comprising a water tank member 200. In this example embodiment, station 101 is for tea, station 102 is for drip coffee and station is for K-cup style coffee brewing. A pump and tube assembly 300 is operably coupled at a distal end of the pump and tube assembly 390 to the water tank member and a proximal end of the pump and tube assembly 310 to three dispensing nozzle members 321, 322, 323. The heated beverage maker includes at least one metal portion of the tube assembly 330. A valve assembly 340 is operably coupled to the pump and tube assembly 300 designed to direct water flow to at least one or more of the dispensing nozzle members 321, 322, 323 selected by the user. At least one water heater assembly 360 is operably coupled to at least one metal portion of the tube assembly 330.

The heater beverage maker 10 includes a water level indicator viewing port 210. The heater beverage maker 10 further includes at least one grated container member with a watertight basin 370. A plurality of top lid members 230 is designed for adding water and at least one brewing medium. The heater beverage maker includes at least one removable carafe member 240. A plurality of drawer members 120 is slidably disposed within the housing assembly 100. The heater beverage maker includes at least one tray member 130 with at least one sidewall member 135. The heater beverage maker includes at least one removable beverage medium pod container member 400 with a plurality of bottom hole members 402 having a pod container lid member 410, the pod container lid member 410 having a central hole member 415, each central hole member 415 aligned to a user-selected one of the three dispensing nozzle members 321, 322, 323 when making a beverage.

At least one rack portion 500 is disposed within the housing assembly 100 with a plurality of horizontally disposed, C-shaped holder members 501, the open bowl of the C-shaped K-cup style holder members 502 outwardly disposed. A control panel assembly 700 is designed to control at least one or more of power, time, timer, timing, pre-programming, cleaning, beverage size, type of beverage, beverage strength, drip style, temperature, start of a brewing cycle, end of a brewing cycle, and brewing station selection. A power assembly 720 with at least one power cord member 740 is designed to be plugged into an outlet.

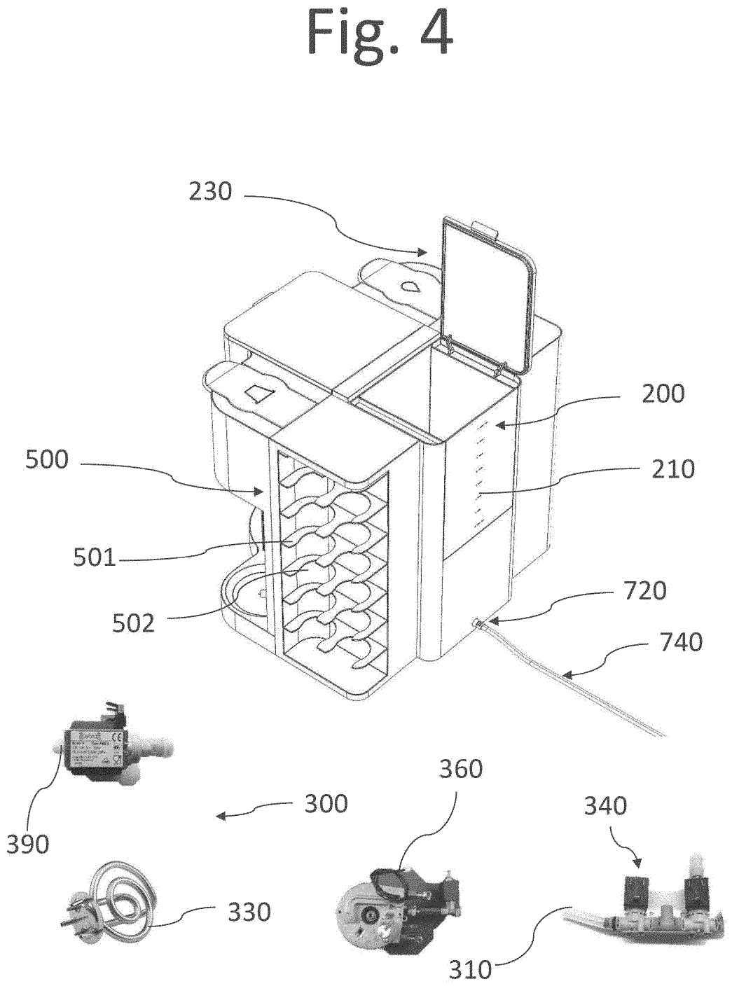

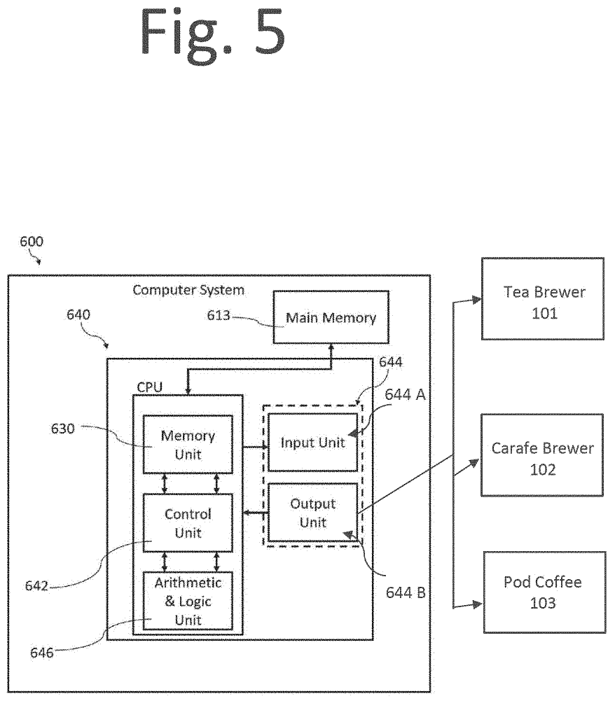

Referring now to FIGS. 4 and 5, there is illustrated a schematic of a brewing control system 600, which includes at least one central processing unit 640 operably coupled to the control panel assembly 700 and electrically coupled to the power assembly 740 designed to process commands from the control panel 700. This embodiment of the heated beverage maker 10 includes at least one hot plate assembly 510. In this embodiment of the heated beverage maker for a user, at least one tray member 130 is disposed beneath the at least one grated container member 370.

With reference to FIG. 5, a central processing unit (CPU) 640, also called a central processor or main processor, is the electronic circuitry within a computer 600 that executes instructions that make up a computer program. The CPU 640 performs basic arithmetic, logic, controlling, and input/output (I/O) operations specified by the instructions in the program. An arithmetic & logic unit (ALU) 646 is a combination digital electronic circuit that performs arithmetic and bitwise operations in integer binary numbers. Traditionally, the term CPU 640 refers to a processor, more specifically to its processing unit and control unit (CU) 642, distinguishing these core elements of a computer from external components such as main memory 613 and input output (I/O) circuitry 644, comprised of input circuitry 644A and output circuitry 644B which control operations for tea brewer 101, carafe brewer 102 and pod or K-cup style coffee brewer 103. A CPU 640 may also contain memory 630. Memory 630 refers to a component that is used to store information for immediate use in a computer 600.

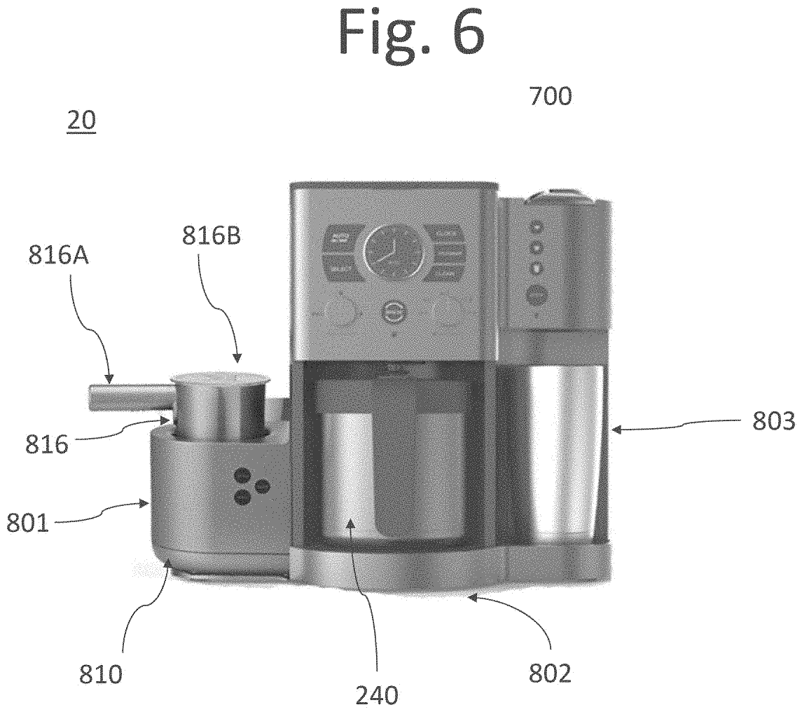

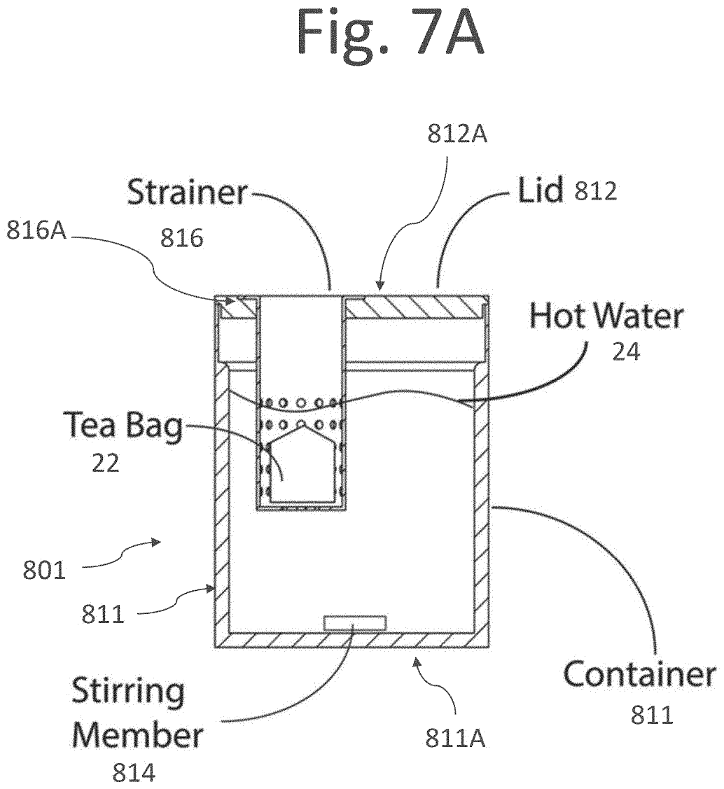

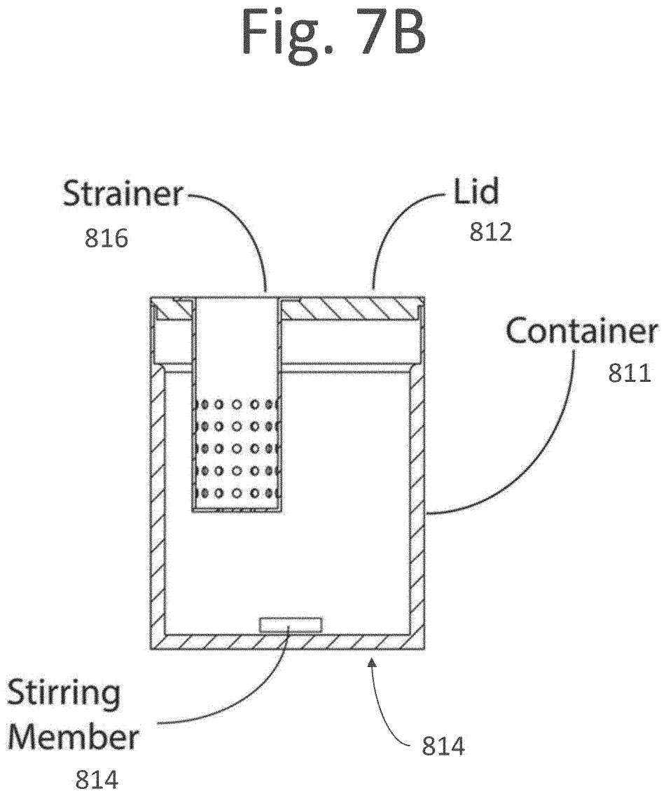

Referring now to FIGS. 6-8, a second embodiment of a multi-purpose drink appliance or machine 20 is shown which has some similar components as drink machine or appliance 10 but includes improvements which will be described hereinafter.

In particular, appliance 20 includes a hot milk frother device or station 801 which includes a base assembly 810 and a container assembly 811 and fitted lid 812 for holding milk, milk substitutes, water or any other desired liquid beverage. The base assembly 810 (within a housing) contains a heating element 820 and a rotating magnet assembly 822. Container 811 further includes a stirring member 814 resting on the container floor 811A that is caused to rotate by the rotating magnet 822 in the base assembly 810. The structure of the base assembly and the container and stirring member is similar to other hot milk frothers in production (such as the RATRSO hot and cold milk frother). In a related embodiment, base 810 includes an inductive assembly that forms a magnetic field that acts as a motive force on a metal stirring member to generate the stirring motion or action within container 811.

In this example embodiment, a lid 812 of the container 811 has a hole 812A located at or near a center axis of the container 811. The lid 812 supports a removable strainer 816 that can be inserted into the hole 812A at top of the lid 812, which can be used to hold loose tea or bags of tea 22 or spices such as cinnamon. The stirring member 814 preferably includes a whisk (circular spring or star-shaped) or an elongate pellet to form the stirring action in the milk frother of station 801. Strainer 816 may also incorporate a handle 816A that is exposed above the lid so that it is easy to remove when hot. When the strainer 816 is not in use, a cap 816B may be used to cover the hole 812A in the lid 812, and the same cap 816B may also be used to cover the top of the strainer 816 when it is in use.

In this example embodiment of hot milk frother 801, strainer 816 is a tea infuser basket to hold tea bag 22 or other herbs or spices. The tea infuser basket 816 allows rapid preparation of teas as a result of the forced convection flow of hot water 24 (or hot milk) around the tea basket 816. The basket 816 is designed so that its upper rim would be supported by the upper rim or lid 812 of the milk frother device and the cover 816B of the milk frother 801 will be usable either with the basket/strainer 816 or without the basket. The shape of the basket/strainer 816 increases fluid flow inside of the aqueous liquid or beverage while still preventing the tea 22 from leaking out of the basket. The fluid flow will lift the tea leaves or bag 22 off of the bottom of the tea infuser basket 816 for more even circulation of the water around the tea leaves but prevents the tea leaves from going into the liquid (e.g., milk or water) to be consumed.

In one example embodiment, milk frother/tea brewer 801 will incorporate a timer feature that allows the user to increase or decrease the strength of the tea by controlling the time and speed of an agitation motor located in base 810 as well as controlling a heater and a corresponding heater power level and time of infusion or stirring. For example, for a less strong tea, the agitator motor will run for a shorter time and will be sequenced with the heater so that it does not turn on until the water has almost reached the final desired temperature for the tea. For stronger tea, the agitator motor will run at a higher speed for a longer period of time.

In this example embodiment, a power control circuit operatively coupled to CPU 640 will prevent appliance 20 from consuming more power or current draw than the wall outlet can accommodate, and will allow beverages to be prepared more rapidly if fewer components are running simultaneously that would also be drawing power or current. For example, if the user wants to prepare a pot of coffee and does not need to use the pod coffee or the frother, then more power will flow to the carafe coffee maker. If the user wants to use all three beverage makers simultaneously, then the power control circuit will ensure that less power will be allocated to each beverage maker so that the power limitations of the wall outlet are not exceeded.

In yet another related embodiment, a sequencer circuit operatively coupled to CPU 640 is included and functions to allow the user to add milk to the frother container 811 at the same time as the user starts to prepare a carafe of coffee yet the milk heating and frothing will occur so that the “frothed” milk is ready at the same time that the pot of coffee is ready. With the sequencer circuit and feature, the user will be able to select whether beverages and frothed milk are “ready together” or “ready ASAP.” Hence, the frothed milk will not be sitting too long and lose its foamy consistency and warm temperature while waiting for the brewing coffee to be ready. The sequencer function can also be used so that the coffee pot and the single serving of coffee are ready simultaneously. For example, 4 cups of regular coffee are being made in the pot and one cup of decaf is being prepared in the single serving coffee maker. The pot will start first and the cup will start later so that both beverages are finished brewing at the same time.

In another example embodiment, frother base assembly 810 is integrated directly into the pod or carafe station to reduce the footprint of the machine. For instance, when the pod station 803 is not in use, container 811, with handle 816A and cover 816B is inserted into the opening of station 803 and its associated base (which includes a heater and a rotating magnet or inductive assembly) to make the frothed milk. In another related embodiment, appliance 20 is configurable to provide for milk or liquid “froth” to be heated and frothed (or re-frothed) without using a separate container, thereby providing of the advantage of less cleaning of components.

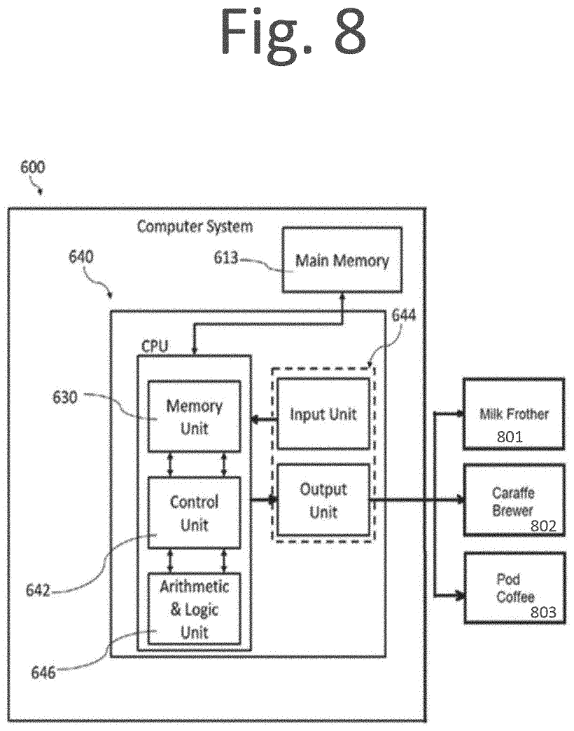

Referring briefly to FIG. 8, similar to FIG. 5, there is illustrated a schematic of the brewing system for appliance 20. In this example embodiment, 2-3 brewing stations (801, 802 and 803), depending on the device, are controlled by system 600 and CPU 640. Further this circuit is modified in other embodiments to include the power level control circuit as well as the sequencer circuit and the agitation motor control for tea making applications.

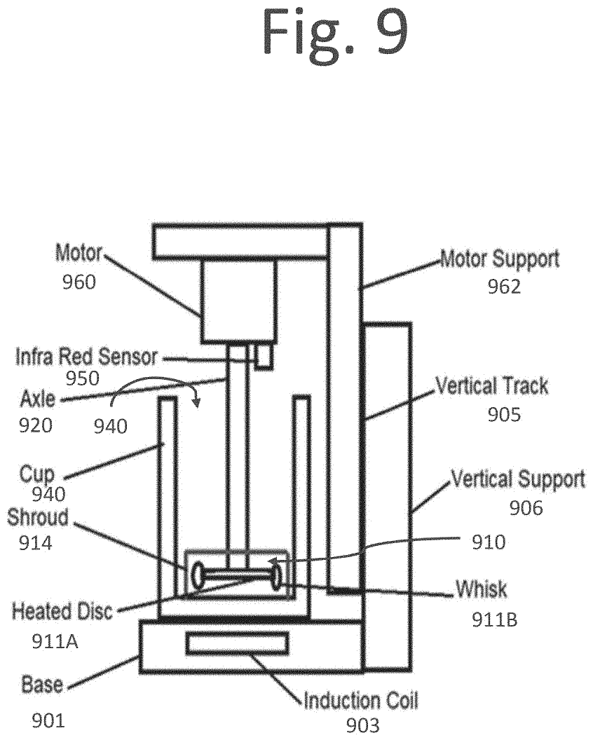

Referring now to FIG. 9, a heated frother assembly and accessory 900 is described and can be integrated into the various embodiments of brewing systems described herein. The brewing systems described herein can include a heated frother whisk 910 for use in any cup or mug 940. This will allow the user to prepare frothed milk in the same cup that they use to drink their coffee and avoid cleaning a separate frothing container. Heated frother whisk device 910 is supported from above by an axle 920, about which the whisk will spin. An electrical resistance heating element is incorporated into a disc 911A with its center coincident with axle 920. A whisk element 911B will be circular in shape as is typical for milk frothing whisks and may be attached to disc 911A.

At least one heat sensor 950 is incorporated into the Hot Frother Whisk assembly to measure the temperature of the milk (or other milk like products, such as soy, almond, coconut or rice milk) so that the milk can be heated to the proper temperature without overheating it. In a preferred embodiment, the heat sensor 950 is an infra-red sensor located above the milk and cup opening 941, which provides remote temperature readings taken from viewing the upper surface of the milk. Data from the heat sensor will be transmitted to the beverage maker computer or processor that controls the speed of the whisk device 910 and the temperature of the heating element 911A and the timing of both.

A splash guard or shroud 914 disposed over whisk 911B prevents the spinning whisk 911B and heating element 911A from spraying liquid out of the cup 940 in which it is being prepared. In a preferred embodiment, the splash guard 914 consists of a non-rotating shroud that covers the top and sides of the rotating whisk. The shroud 914 is also supported by the axle 920 of the whisk assembly 910, which will be rotatably coupled to the shroud 914, and is in contact with the lower surface or floor of the cup 940 so that friction between the lower surface or rim of the shroud 914 and the cup 940 prevents the shroud 914 from spinning. Holes or slots (not shown) in the shroud will allow the milk (or other liquid) to circulate from outside of the shroud to the whisk 911B located inside of the shroud 914.

In an alternative embodiment, the splash guard or shroud 914 is a one size fits all non-rotating disc that rests on the upper surface of the cup and has a hole at its center through which the axle 920 passes.

The rotating whisk element 911B may be powered from a motor 960 (supported by motor support 962) located above the whisk element 911B and connected to its axle 920 as is conventional for many hand-held frothers or immersion blenders. Alternatively, the rotating whisk may be powered by a rotating magnet located in the base below the cup as is common in many hot milk frothers, in which case, the rotating whisk would also incorporate a magnet in its supporting structure.

The electrical resistance heating element 911A may be powered by an electromagnetic induction coil 903 located in the base 901 below the cup 940, where electrical resistance heating element 911A is an iron-based disc that heats up when it is placed close to the electromagnetic induction coil 903. Alternatively, the electrical resistance heating element 911A may be a resistance coil in the disc that is powered by an electrical connection to rotating contacts that run from the disc through the axle to electrical contacts located near the upper end of the axle 920.

In order to make sure that the rotating whisk 911B and heating element 911A are located close to the bottom of the cup 940, the hot frother whisk device 910 may be attached to a vertical track 905 disposed on a vertical support 906 on which the hot frother whisk device 911 slides. In this way, the hot frother whisk 911B can be raised up in order to position the cup 940 and lowered down so that the whisk 911B is positioned close to the bottom of the cup 940.

The following patents are incorporated by reference in their entireties: U.S. Pat. publication Nos. 20030066431A1; 20040065209A1; 2018/0303273; 2020/0277131; and U.S. Pat. No. 9,113,747.

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A beverage maker or appliance comprising:
a housing assembly with at least two brewing stations further including a water source for common or shared usage by each brewing station;
a pump and tube assembly operably coupled between the water source and at least two dispensing nozzle members, the dispensing nozzle members having distal ends directed at one of at least a pod carrier or a coffee basket;
a valve assembly operably coupled to the pump and tube assembly and adapted to direct water flow to one or more dispensing nozzle members selected by a user;
at least one water heater assembly operably coupled to the valve assembly and the pump and tube assembly adapted to provide heated water to the dispensing nozzle member;
a frothing assembly including a container assembly and a stirring assembly, the container assembly including a container supporting a strainer and a stirring member;
a control panel assembly adapted to control at least one or more of power, time clock, timer, timing, pre-programming, cleaning, beverage size, type of beverage, beverage strength, drip style, temperature, start of a brewing cycle, end of a brewing cycle, brewing station selection, and stirring;
a power assembly with at least one power cord member adapted to be plugged into an outlet; and
at least one central processing unit (CPU) operably coupled to the control panel assembly and electrically coupled to the power assembly adapted to process commands from the control panel.

2. The heated beverage maker for a user in claim 1 further comprising an agitator assembly including an agitation motor located adjacent the container assembly and adapted to agitate an aqueous solution.

3. The heated beverage maker for a user in claim 1 wherein the frothing assembly is configured for use as a tea brewing station.

4. The beverage maker of claim 3 wherein the tea brewing station includes a stirring assembly including a rotating magnet for imparting a magnetic force on the stirring member within the container.

5. The beverage maker of claim 1 wherein the CPU and the control panel assembly include a power level control circuit adapted to control and monitor power and current usage between brewing stations and the frothing assembly to enable simultaneous operation without exceeding current drawn on an alternating current source.

6. The beverage maker of claim 1 wherein the CPU and the control panel assembly include a sequencer control circuit adapted to control the sequence of at least one of a water heating, frothing of an aqueous liquid and agitation of an agitation motor.

7. The beverage maker of claim 1 further including a water spigot assembly adapted to receive water from the water source and direct the water to at least one of the brewing stations and the frothing assembly.

8. The beverage maker of claim 1 further including a plurality of drawer members slidably disposed within the housing assembly.

9. The beverage maker of claim 1 further including at least one rack portion disposed within the housing assembly with a plurality of horizontally disposed, C-shaped holder members, the open bowl of the C-shaped holder members outwardly disposed.

10. The beverage maker of claim 1 wherein the two brewing stations provide functionality for brewing coffee with a carafe, brewing coffee through a K-cup style pod, frothing of a dense aqueous solution and herbal tea infusion and preparation.

11. A frothing assembly comprising:
a housing assembly with a base portion, a vertical support member coupled to the base portion and extending longitudinally therefrom, a vertical track member ;
a motor support column member movably coupled co-linearly to the vertical support member at the vertical track, the motor support column member adapted to move in the vertical direction along the vertical track, the motor support column having an arm extending laterally therefrom and over the base portion;
a motor assembly coupled to the laterally extending arm, the motor assembly extending downward towards the base portion and including and an axle member protruding down from the motor assembly, wherein the axle is coupled at a proximal end to the motor assembly is adapted to be rotated by the motor assembly upon actuation; and
a whisk assembly including a whisk member disposed on a disc or circular plate, wherein the disc is adapted to be attached to a distal end of the axle to enable spinning or rotating of the disc and whisk member;
wherein the base portion is adapted to receive a container or cup with an opening that extends up from the base portion and towards the axle member and the whisk assembly.

12. The frothing assembly of claim 11 wherein the axle member includes a shroud or cover that extends over and in close proximity to the whisk assembly.

13. The frothing assembly of claim 11 wherein the base portion is capable of receiving power from an external source to power the components of the frothing assembly and to power an induction coil assembly disposed within the base portion.

14. The frothing assembly of claim 13 wherein the disc or circular plate is metal and the induction coil assembly, upon activation, provides energy to the metal disc to generate resistive heating about the whisk member.

15. The frothing assembly of claim 11 further comprising an infrared sensor located on the motor assembly adjacent the axle member, the infrared sensor adapted to sense temperature of a fluid in the container located on the base portion.

16. The frothing assembly of claim 11 further comprising:
a control panel assembly adapted to control at least one or more of power, temperature of a frothed liquid, start of a frothing cycle, and end of a frothing cycle;
a power assembly disposed within the base portion with at least one power cord member adapted to be plugged into an outlet; and
at least one central processing unit operably coupled to the control panel assembly and electrically coupled to the power assembly adapted to process commands from the control panel.
